(19) United States
(12) Patent Application Publication
(10) Pub. No.: US 2013/0108894 A1
(43) Pub. Date: May 2, 2013

(54) SECONDARY BATTERY

(71) Applicant: Yeon-Sung JUNG, Yongin-si (KR)

(72) Inventor: Yeon-Sung JUNG, Yongin-si (KR)

(21) Appl. No.: 13/590,462

(22) Filed: Aug. 21, 2012

(30) Foreign Application Priority Data
Nov. 2, 2011 (KR) 10-2011-0113591

(51) Int. Cl. H01M 2/00; H01M 10/50

(52) U.S. Cl. 429/7

(57) ABSTRACT

A secondary battery includes a plurality of unit batteries, a circuit board having at least one heat dissipation opening therethrough, and a balancing circuit on the circuit board, the balancing circuit including at least one balancing switch configured to switch ON/OFF states according to an output signal of a control unit, and at least one balancing resistor configured to form a discharge circuit of the plurality of unit batteries according to the ON/OFF states of the balancing switch, at least a part of the balancing resistor being exposed through the at least one heat dissipation opening in the circuit board.

### BACKGROUND

1. Field

One or more example embodiments relate to a secondary battery capable of discharging.

2. Description of the Related Art

As technologies for mobile devices, e.g., mobile phones and notebook computers, are developed and production of the mobile devices increases, demand for a secondary battery as an energy source is sharply increased. Recently, secondary batteries have been actively developed as a replacement energy source for fossil fuel for use of, e.g., electric vehicles, hybrid vehicles, etc.

By electrically connecting a plurality of battery cells, a secondary battery may be used, e.g., as a power storage device for storing power in each battery cell and supplying the stored power when necessary. In the secondary battery, in which the battery cells are connected to one another, a cell balancing operation may be performed to monitor a voltage state of each battery cell and remove imbalance in voltage among the respective battery cells.

### SUMMARY

One or more example embodiments relates to a secondary battery that may rapidly dissipate resistance heat of a balancing resistor to the outside.

According to one or more embodiments of the present invention, a secondary battery may include a plurality of unit batteries, a circuit board having at least one heat dissipation opening therethrough, and a balancing circuit on the circuit board, the balancing circuit including at least one balancing switch configured to switch ON/OFF states according to an output signal of a control unit, and at least one balancing resistor configured to form a discharge circuit of the plurality of unit batteries according to the ON/OFF states of the balancing switch, at least a part of the balancing resistor being exposed through the at least one heat dissipation opening in the circuit board.

The balancing resistor may extend across the heat dissipation opening, opposite end portions of the balancing resistor being on opposite sides of the heat dissipation opening and coupled to an installation land of the circuit board.

The secondary battery may further include a heat dissipation pattern extending along a surface of the circuit board and facing the balancing resistor, the heat dissipation pattern having thermal contact with at least a part of the balancing resistor.

The heat dissipation pattern may surround the heat dissipation opening.

The heat dissipation pattern may include a first portion extending along a first direction to cross the balancing resistor, the first portion having thermal contact with the balancing resistor, and a second portion extending along a second direction from the first portion, the second portion being configured to provide a heat dissipation surface and having a width along the first direction larger than a width of the first portion along the second direction.

The first portion may extend along two opposite sides of the heat dissipation opening, and the second portion extends along two opposite sides of the heat dissipation opening.

The balancing resistor may be arranged across the heat dissipation opening and the heat dissipation pattern, opposite end portions of the balancing resistor being coupled to an installation land of the circuit board at opposite sides of the heat dissipation opening and the heat dissipation pattern.

At least two balancing resistors may be arranged on the circuit board, the at least two balancing resistors corresponding to different discharge circuits connected to different unit batteries.

The heat dissipation opening may overlap the at least two balancing resistors.

The secondary battery may further include a heat dissipation pattern extending along a surface of the circuit board and facing the at least two balancing resistors, the heat dissipation pattern having thermal contact with the at least two balancing resistors.

The heat dissipation pattern may surround the heat dissipation opening.

The heat dissipation pattern may include a first portion extending across the at least two balancing resistors and having thermal contact with the at least two balancing resistors, and a second portion extending outside of the first portion and providing a heat dissipation surface extended from the first portion.

The first portion may extend across the at least two balancing resistors along two opposite sides of the heat dissipation opening, and the second portion may include a branch portion protruding from the first portion extending between the at least two balancing resistors, and an extension portion outside the heat dissipation openings and connecting the first portion on the opposite sides of the heat dissipation opening, the extension portion being configured to provide a heat dissipation surface.

The at least two balancing resistors may be parallel to each other and extend across the heat dissipation opening and the heat dissipation pattern, opposite end portions of the at least two balancing resistors being coupled to the installation land of the circuit board at opposite sides of the heat dissipation opening and the heat dissipation pattern.

The at least two balancing resistors may be on opposite surfaces of the circuit board, the heat dissipation opening overlapping the at least two balancing resistors.

The at least two balancing resistors may be at different positions on the circuit board not to overlap with each other through the heat dissipation opening.

The secondary battery may further include a first heat dissipation pattern and a second heat dissipation pattern on the opposite surfaces of the circuit board, respectively, the first and second heat dissipation patterns contacting the at least two balancing resistors, respectively.

A surface of the circuit board facing the unit batteries may be positioned at a predetermined distance from the unit batteries to define a space therebetween, the at least, one balancing resistor being exposed to the space between the circuit board and unit batteries through the opening of the circuit board.

### BRIEF DESCRIPTION OF THE DRAWINGS

Features will become apparent to those of ordinary skill in the art by describing in detail exemplary embodiments with reference to the attached drawings, in which:

FIG. 1 illustrates an exploded perspective view of a secondary battery according to an embodiment;

FIG. 2 illustrates an enlarged perspective view of a part of the secondary battery of FIG. 1;

FIG. 3 illustrates a circuit diagram of a cell balancing circuit mounted on a BMS of FIG. 1;

FIG. 4 illustrates a perspective view of a heat dissipation structure of a balancing resistor;

FIG. 5 illustrates an enlarged perspective view of the balancing resistor of FIG. 4;

FIG. 6 illustrates a cross-sectional view taken along line VI-VI of FIG. 5;

FIG. 7 illustrates a perspective view of a heat dissipation structure of a balancing resistor according to another embodiment;

FIG. 8 illustrates a perspective view of a heat dissipation structure of a balancing resistor according to another embodiment;

FIG. 9 illustrates a perspective view of a heat dissipation structure of a balancing resistor according to another embodiment;

FIG. 10 illustrates a cross-sectional view taken along line X-X of FIG. 9;

FIG. 11 illustrates a perspective view of a heat dissipation structure of a balancing resistor according to another embodiment;

FIG. 12 illustrates a plan view of a heat dissipation structure of FIG. 11;

FIG. 13 illustrates a cross-sectional view taken along line XIII-XIII of FIG. 11;

FIG. 14 illustrates a perspective view of a heat dissipation structure of a balancing resistor according to another embodiment;

FIG. 15 illustrates a plan view of heat dissipation structure of FIG. 14; and

FIG. 16 illustrates a perspective view of a heat dissipation structure of a balancing resistor according to another embodiment.

### DETAILED DESCRIPTION

Korean Patent Application No. 10-2011-0113591, filed on Nov. 2, 2011, in the Korean Intellectual Property Office, and entitled: “Secondary Battery,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when an element, e.g., a layer, is referred to as being “on” another element or substrate, it can be directly on the other element or substrate, or intervening elements may also be present. In addition, it will also be understood that when an element is referred to as being “between” two elements, it can be the only element between the two elements, or one or more intervening elements may also be present. Like reference numerals refer to like elements throughout.

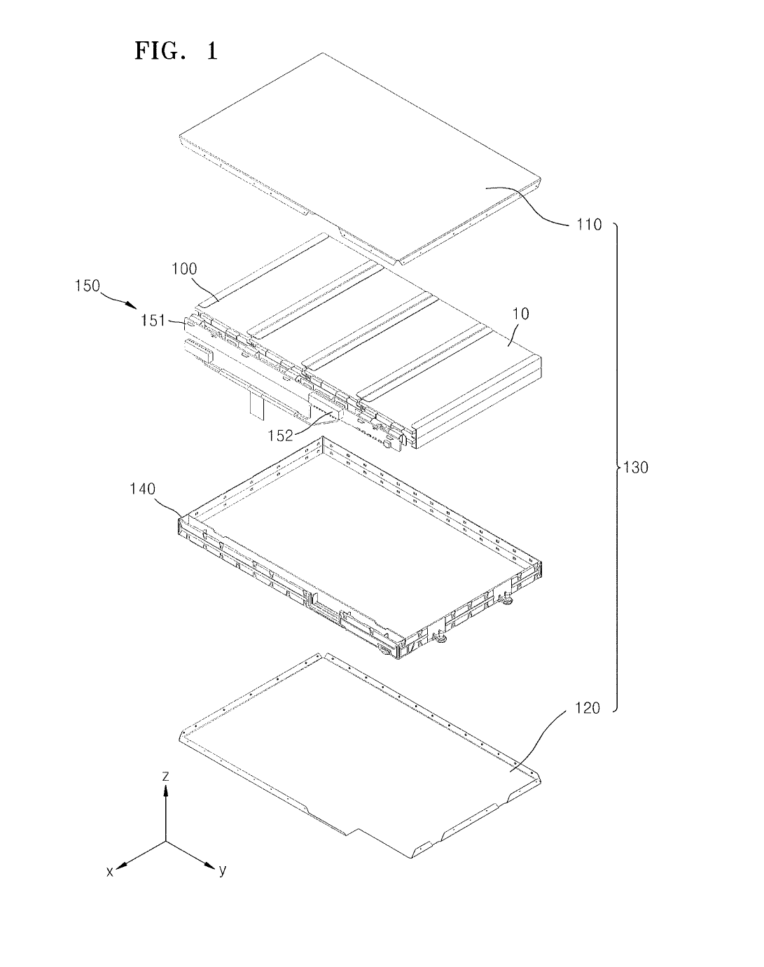

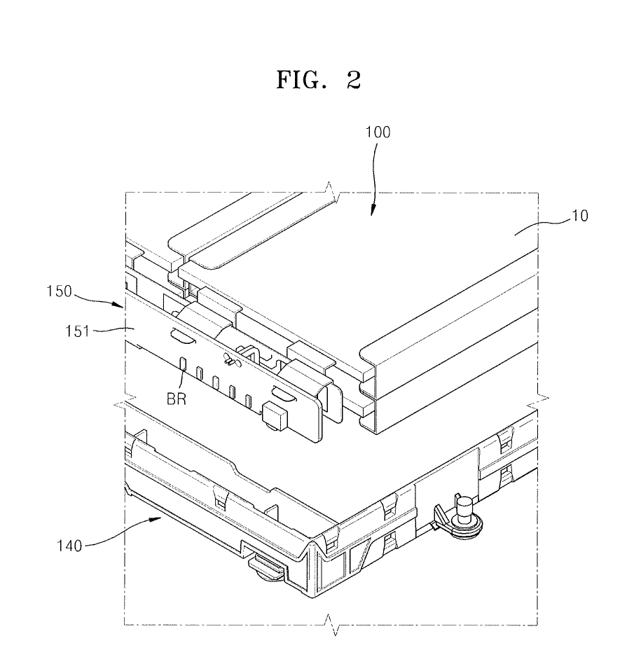

FIG. 1 is an exploded perspective view of a secondary battery according to an embodiment. FIG. 2 is a perspective view of a part of the secondary battery of FIG. 1.

Referring to FIGS. 1 and 2, a secondary battery according to example embodiments may include a core pack 100, a battery management system (BMS) 150, a frame 140, and a cover 130.

The core pack 100 may include a plurality of unit batteries 10 capable of charging and discharging. For example, the core pack 100 may be a battery stack in which at least two unit batteries 10 are stacked and electrically connected to one another. For example, when the unit batteries 10 adjacent to each other are connected with a same polarity, the unit batteries 10 make a parallel connection. When the unit batteries 10 adjacent to each other are connected with opposite polarities, the unit batteries 10 make a serial connection. The unit batteries 10 may have, e.g., a substantially rectangular form, and may be stacked with adjacent surfaces contacting each other.

The frame 140 may accommodate the core pack 100 and the BMS 150. The frame 140 has a structure capable of coupling to the cover 130 while accommodating the core pack 100 and the BMS 150. For example, the frame 140 may have a substantially rectangular edge shape.

The cover 130 may accommodate the core pack 100 therein, and may be coupled to the frame 140. As illustrated in FIG. 1, the cover 130 may include an upper cover 110 and a lower cover 120. In another embodiment, the cover 130 may be integrally provided without being separated into upper and lower portions. For example, the cover 130 may be in a thin plate form.

Although it is not illustrated, an insulation tape (not shown) may be arranged between the cover 130 and the core pack 100. The insulation tape may insulate between the cover 130 and the core pack 100, which include metal. The insulation tape may also insulate between the cover 130 and the BMS 150.

In the assembly of a secondary battery, the cover 130 may be assembled to the frame 140, accommodating the core pack 100 and the BMS 150, from the up and down sides. That is, the cover 130 may be attached to the top and bottom sides of the frame 140, with the core pack 100 and the BMS 150 being accommodated within a space defined by the frame 140. The cover 130 and the frame 140 may be coupled to each other by using an appropriate coupling member. For example, a plurality of coupling holes may be formed in the cover 130, so that the cover 130 may be coupled to the frame 140 by using a screw member (not shown).

The core pack 100 may be electrically connected to the BMS 150. The BMS 150 may include a circuit board 151 arranged at one side of the core pack 100 and a circuit device 152 mounted on the circuit board 151. The circuit device 152 may include a passive device, e.g., a resistor or a capacitor, or an active device, e.g., a field effect transistor (FET).

The BMS 150 controls charging and discharging operations of a secondary battery. For example, the BMS 150 may detect voltage data from each of the unit batteries 10 and perform a balancing operation to remove a voltage variation by referring to the voltage data measured from the unit batteries 10. The BMS 150 may generate a charge signal or a discharge signal corresponding to a voltage variation among the unit batteries 10. To this end, the BMS 150 may include a balancing circuit.

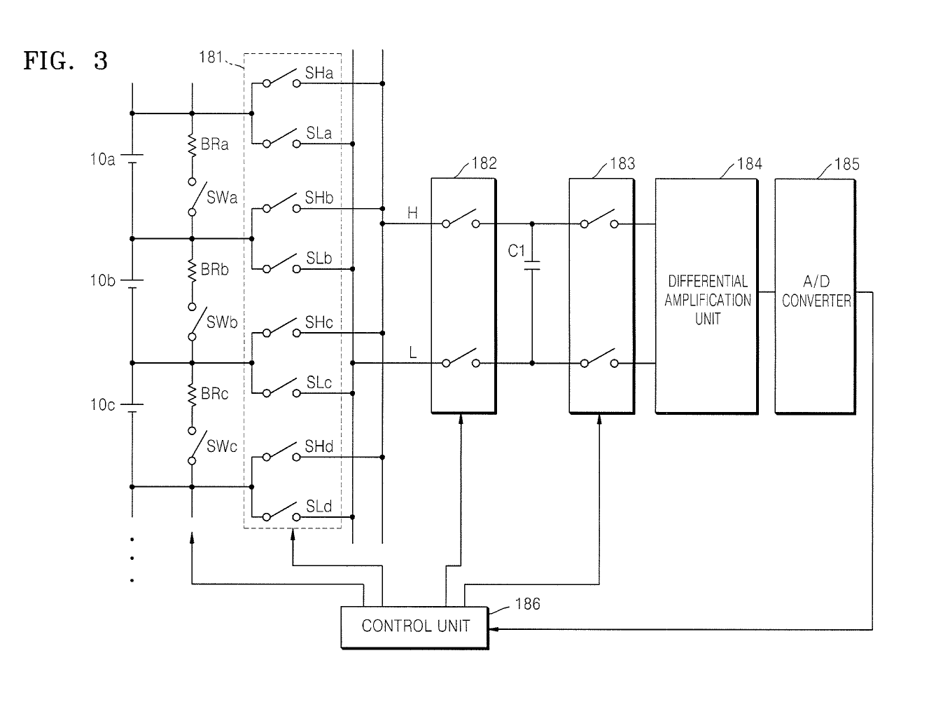

FIG. 3 is a circuit diagram of an exemplary cell balancing circuit mounted on the BMS 150 of FIG. 1. Referring to FIG. 3, the balancing circuit searches for overcharged unit batteries, e.g., of unit batteries 10a, 10b and 10c, by detecting voltages of the respective unit batteries 10a, 10b, and 10c in the secondary battery, and performs discharge of overcharged unit batteries to remove the overcharge, thereby correcting voltage imbalance with other unit batteries 10a, 10b, and 10c. The cell balancing circuit may include a control unit 186 and balancing switches SWa, SWb, and SWc for switching between ON/OFF states according to an output signal of the control unit 186. Also, the cell balancing circuit may include balancing resistors BR1, BR2, and BR3 for forming a closed circuit with the unit batteries 10 according to the ON/OFF states, i.e., operations, of the balancing switches SWa, SWb, and SWc. For example, the balancing switches SWa, SWb, and SWc and the balancing resistors BR1, BR2, and BR3 may be serially connected between one end and another end of each of the unit batteries 10a, 10b, and 10c.

As the control unit 186 individually controls the balancing switches SWa, SWb, and SWc, the respective unit batteries 10a, 10b, and 10c are discharged through the balancing resistors BR1, BR2, and BR3. As such, the respective unit batteries 10a, 10b, and 10c are balanced to have similar voltage levels through the balancing resistors BR1, BR2, and BR3.

The cell balancing circuit may further include circuit components to transfer a voltage between both ends of each of the unit batteries 10a, 10b, and 10c to the control unit 186. For example, the balancing circuit may further include a cell selection circuit 181 for selecting a voltage measurement object, a capacitor C1 for storing the voltage between both ends of a selected one of the unit batteries 10a, 10b, and 10c, a differential amplification unit 184 for amplifying the voltage stored in the capacitor C1, and an analog-to-digital (A/D) converter 185 for converting an output voltage of the differential amplification unit 184 to a form that can be recognized by the control unit 186. For example, the cell selection circuit 181 may include a plurality of selection switches SHa, SHb, SHc, and SHd connected between any one end of each of the unit batteries 10a, 10b, and 10c and a first output terminal H, and a plurality of selection switches SLa, SLb, SLc, and SLd connected between any one end of each of the unit batteries 10a, 10b, and 10c and a second output terminal L.

In FIG. 3, reference numerals 182 and 183 denote first and second relay switches. For example, a voltage between the opposite ends of each of the unit batteries 10a, 10b, and 10c is transferred to the differential amplification unit 184 via the capacitor C1 according to the ON/OFF states of the first and second relay switches 182 and 183.

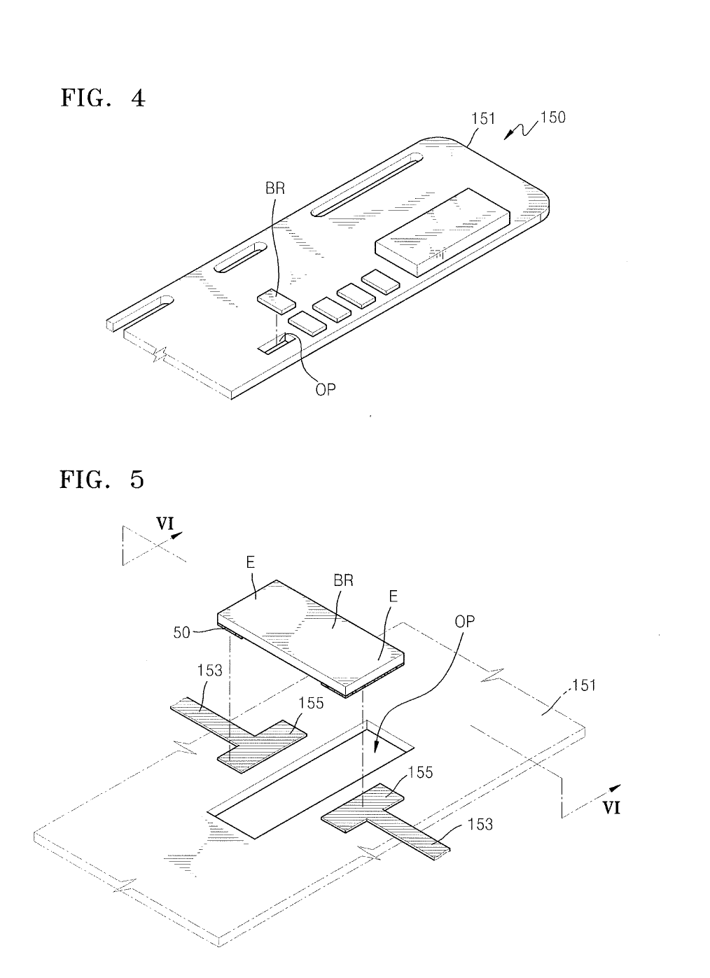

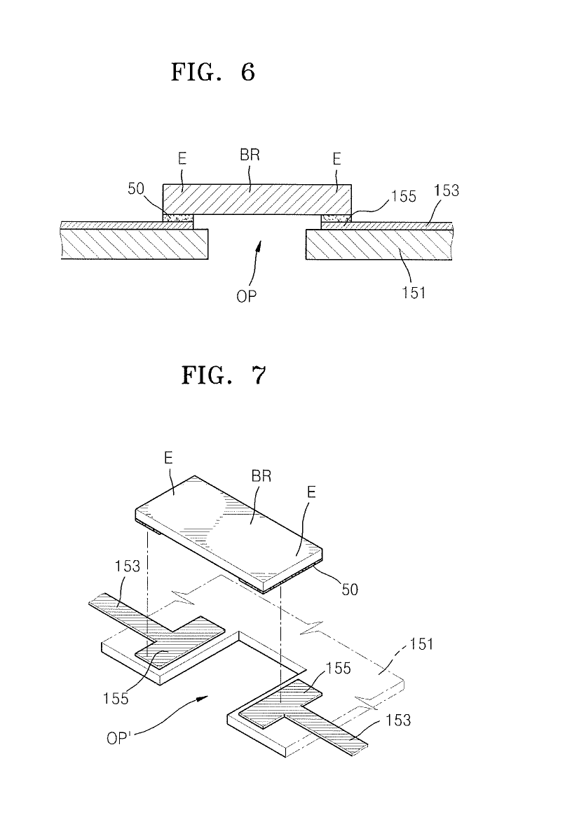

FIG. 4 is a perspective view of a heat dissipation structure of a balancing resistor mounted on the BMS 150 of FIG. 1. FIG. 5 is an enlarged perspective view of the balancing resistor of FIG. 4. FIG. 6 is a cross-sectional view taken along line VI-VI of FIG. 5.

Referring to FIGS. 4-6, a balancing resistor BR may be arranged on the circuit board 151 of the BMS 150. The balancing resistor BR may be formed of a heat generating resistor that may convert discharge current to thermal energy according to a balancing operation. Although in the drawings the balancing resistor BR has a substantially rectangular shape for convenience of understanding, the balancing resistor BR may have a variety of shapes.

Referring to FIGS. 5 and 6, the circuit board 151 of the BMS 150 may include a heat dissipation opening OP, and the balancing resistor BR may be arranged to at least partially overlap the heat dissipation opening OP. That is, the heat dissipation opening OP may be formed through the circuit board 151, so the balancing resistor BR may be positioned over the heat dissipation opening OP to be at least partially exposed from the circuit board 151 through the heat dissipation opening OP, e.g., the exposed portion of the balancing resistor BR may be exposed to an exterior of the circuit board 151 through the heat dissipation opening OP. For example, convection heat is transferred through a surface of the exposed part of the balancing resistor BR, so that resistance heat may be rapidly dissipated to the outside.

In detail, discharge current of one of the unit batteries 10 that is overcharged is passed through the balancing resistor BR to remove voltage variation. Thus, a large amount of resistance heat may be generated in a balancing operation, in which thermal energy is consumed. The generated resistance heat of the balancing resistor BR may be rapidly dissipated to the outside of the circuit board 151 through the heat dissipation opening OP, without affecting other circuit devices mounted on the circuit board 151, e.g., a FET for controlling charge and discharge.

The heat dissipation opening OP exposes the balancing resistor BR from the circuit board 151, so that the resistance heat of the balancing resistor BR may be rapidly dissipated to the outside without being blocked by the circuit board 151 having an insulation characteristic. The heat dissipation of the balancing resistor BR may be facilitated, as the balancing resistor BR directly contacts lower-temperature atmosphere, e.g., as compared to the temperature of the balancing resistor BR, through the heat dissipation opening OP.

As discussed previously, the balancing resistor BR may be mounted on the circuit board 151 to at least partially overlap the heat dissipation opening OP. For example, the balancing resistor BR may be electrically connected to the circuit board 151 adjacent to the heat dissipation opening OP, e.g., a connection of the balancing resistor BR to the circuit board 151 may be in a region of the circuit board 151 adjacent to the heat dissipation opening OP.

For example, in the connection structure between the balancing resistor BR and the circuit board 151, an installation land 155 for electrical connection to the balancing resistor BR may be patterned on the circuit board 151. A wiring pattern 153 for forming a discharge circuit of each of the unit batteries 10 may be formed with the installation land 155 on the circuit board 151. The balancing resistor BR may form a discharge circuit connected to both ends of each of the unit batteries 10 through the installation land 155 and the wiring pattern 153.

For example, the balancing resistor BR may be placed on the circuit board 151 with both end portions E sitting on opposite sides across the heat dissipation opening OP. The installation land 155 for the electrical connection to the balancing resistor BR may be formed at the opposite sides of the heat dissipation opening OP. As the installation land 155 is coupled to each of both end portions E of the balancing resistor BR at the opposite sides of the heat dissipation opening OP, a center portion of the balancing resistor BR may be exposed from the circuit board 151 through the heat dissipation opening OP. A connection electrode 50 for electrical connection to the installation land 155 may be formed at both end portions E of the balancing resistor BR corresponding to the installation land 155.

For example, after the connection electrode 50 of the balancing resistor BR and the installation land 155 of the circuit board 151 are arranged to face each other, soldering junction is performed with an appropriate conductive connection member (not shown) interposed between the balancing resistor BR and the installation land 155, so that the balancing resistor BR may be installed on the circuit board 151. As such, the center portion of the balancing resistor BR may be exposed from the circuit board 151 through the heat dissipation opening OP.

For example, at both end portions E of the balancing resistor BR, the connection electrode 50 may be formed on a lower surface of each of both end portions E. That is, the connection electrode 50 may be formed on the balancing resistor BR to face the circuit board 151, thereby enabling the electrical connection to the installation land 155 on the circuit board 151. The connection electrode 50 of the balancing resistor BR may be electrically connected to the installation land 155. For example, the connection electrode 50 of the balancing resistor BR and the installation land 155 may be electrically connected to each other via the soldering junction with the conductive connection member interposed therebetween.

In another embodiment of the electrical connection structure between the balancing resistor BR and the circuit board 151, the balancing resistor BR may be provided with a lead member (not shown) having one end portion attached to both end portions E and the other end portion extending outside the balancing resistor BR. The balancing resistor BR may be placed on the circuit board 151 with the lead member facing the installation land 155 and coupled to the circuit board 151 through, e.g., soldering. The lead member of the balancing resistor BR and the installation land 155 of the circuit board 151 may be firmly coupled to each other by thermal welding, e.g., soldering.

The heat dissipation opening OP may include any structure capable of exposing at least a part of the balancing resistor BR from the circuit board 151 and may be provided in a form of, e.g., a hole punched through the circuit board 151. The heat dissipation opening OP in the form of a hole may be formed in a closed shape surrounded by a side wall that defines the hole.

In a detailed shape of the heat dissipation opening OP, for example, as illustrated in FIG. 5, the heat dissipation opening OP may be formed in a rectangular shape extending across the balancing resistor BR and may be formed in a variety of shapes. For example, the heat dissipation opening OP may include a plurality of heat dissipation openings OP separated from one another and may be formed in a curved shape, e.g., a circle or an oval, or a polygonal shape, e.g., a rectangle.

FIG. 7 is a perspective view of a heat dissipation structure of a balancing resistor according to another embodiment. Referring to FIG. 7, the balancing resistor BR may be installed on the circuit board 151, such that at least a part of the balancing resistor BR can be exposed from the circuit board 151 through a heat dissipation opening OP′ formed in the circuit board 151. The heat dissipation opening OP′ may be formed at an edge area of the circuit board 151 in a form of a dent recessed from the edge of the circuit board 151 opening to the outside of the circuit board 151, e.g., the heat dissipation opening OP′ may have an open shape.

The balancing resistor BR may extend across the heat dissipation opening OP′, and the connection electrode 50 for the electrical connection to the circuit board 151 may be formed at both end portions E of the balancing resistor BR. The installation land 155 may be patterned at a position corresponding to the connection electrode 50 of the balancing resistor BR, i.e., at opposite sides of the heat dissipation opening OP′.

The balancing resistor BR may be placed on the circuit board 151 with the connection electrode 50 at both end portions E facing the installation land 155 of the circuit board 151. The balancing resistor BR may be installed on the circuit board 151 by using conductive coupling, e.g., soldering.

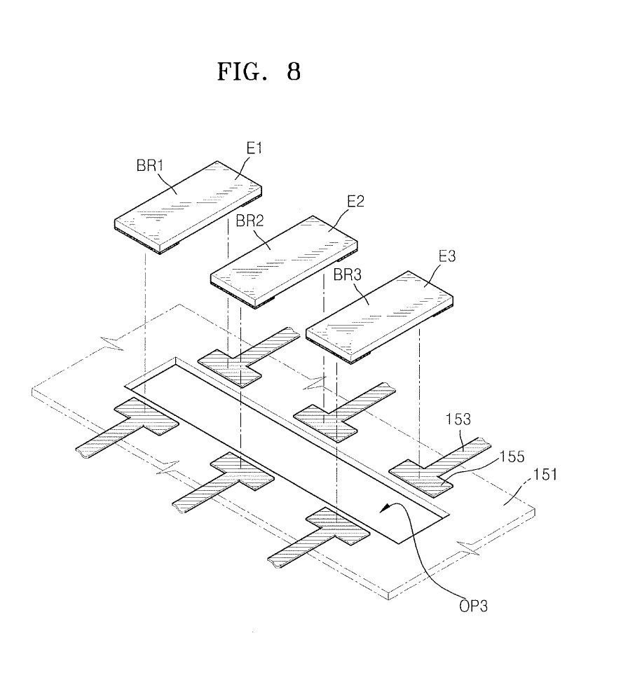

FIG. 8 is a perspective view of a heat dissipation structure of a plurality of balancing resistors, e.g., balancing resistors BR1, BR2, and BR3, according to another embodiment. Referring to FIG. 8, a heat dissipation opening OP3 for simultaneously exposing a plurality of balancing resistors BR1, BR2, and BR3 may be formed in the circuit board 151 of the BMS 150. That is, two or more balancing resistors BR1, BR2, and BR3 may share a single heat dissipation opening OP3, e.g., the heat dissipation opening OP3 may extend to overlap simultaneously and continuously the balancing resistors BR1, BR2, and BR3 and spaces therebetween, so that each of the balancing resistors BR1, BR2, and BR3 may be exposed through the shared heat dissipation opening OP3.

In detail, the heat dissipation opening OP3 may extend in a first direction. Two or more balancing resistors BR1, BR2, and BR3 may be arranged adjacent to each other along the first direction, so each of the balancing resistors BR1, BR2, and BR3 may extend along a second direction across the heat dissipation opening OP3. The balancing resistors BR1, BR2, and BR3 may be arranged parallel to one another, as illustrated in FIG. 8.

The balancing resistors BR1, BR2, and BR3 may be provided in a plural number to connect both ends of each of the unit batteries 10, forming a discharge circuit with respect to each of the unit batteries 10 according to ON/OFF states of a switching device, e.g., the balancing switches SWa, SWb, and SWc (see FIG. 3), serially connected to the balancing resistors BR1, BR2, and BR3.

For example, the balancing resistors BR1, BR2, and BR3 may be provided in a plural number corresponding to the unit batteries 10, to share the single heat dissipation opening OP3, thereby cooling the balancing resistors BR1, BR2, and BR3 through the heat dissipation opening OP3. For example, a group of the balancing resistors BR1, BR2, and BR3 provided in a secondary battery may be cooled by using the heat dissipation opening OP3.

For example, the heat dissipation opening OP3 may expose one surface of each of the balancing resistors BR1, BR2, and BR3, facing the circuit board 151, from the circuit board 151, thereby dissipating the resistance heat of the balancing resistors BR1, BR2, and BR3 through the exposed surfaces. For example, the balancing resistors BR1, BR2, and BR3 may be installed on the circuit board 151 with both end portions E1, E2, and E3 sitting on the opposite sides of the heat dissipation opening OP3. The installation land 155 may be formed at a position adjacent to the heat dissipation opening OP3 of the circuit board 151. The installation land 155 may be patterned in an array corresponding to the balancing resistors BR1, BR2, and BR3. The connection electrode 50 or a lead member (not shown) for the electrical connection to the installation land 155 may be formed on both end portions E1, E2, and E3 of the respective balancing resistors BR1, BR2, and BR3.

The end portions E1, E2, and E3 of the respective balancing resistors BR1, BR2, and BR3 may be arranged in an area of the circuit board 151 outside the heat dissipation opening OP3, sitting on the opposite sides of the heat dissipation opening OP3. The connection electrode 50 for installing the balancing resistors BR1, BR2, and BR3 on the circuit board 151 may be formed on the end portions E1, E2, and E3 of the balancing resistors BR1, BR2, and BR3. The central areas of balancing resistors BR1, BR2, and BR3, except the end portions E1, E2, and E3, overlap the heat dissipation opening OP3 to be exposed from the circuit board 151, so that heat dissipation may be facilitated through the exposed central areas.

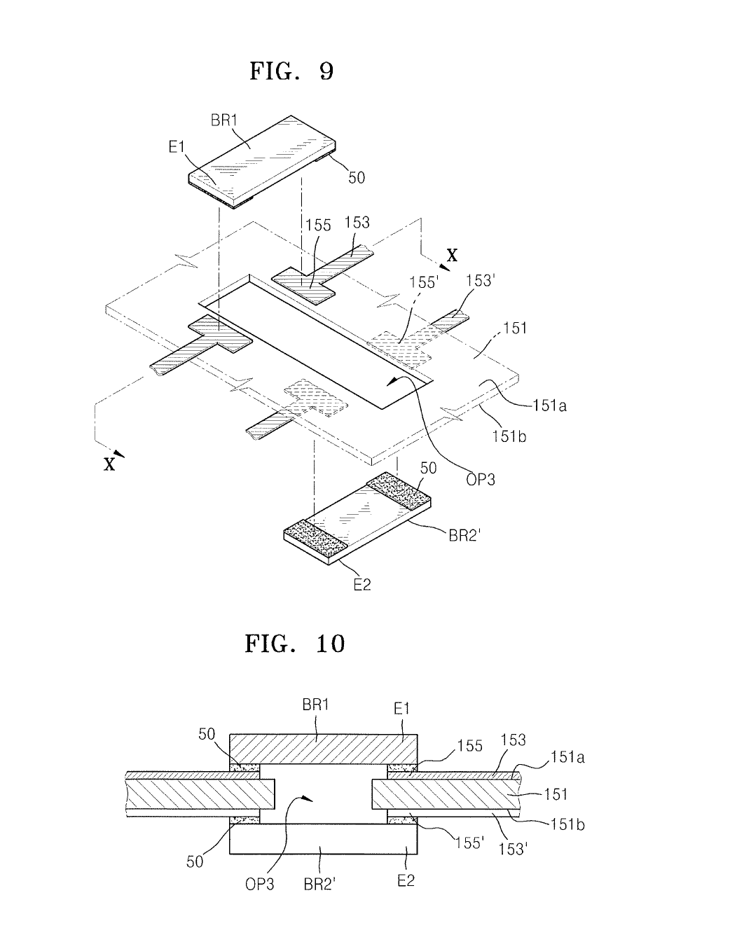

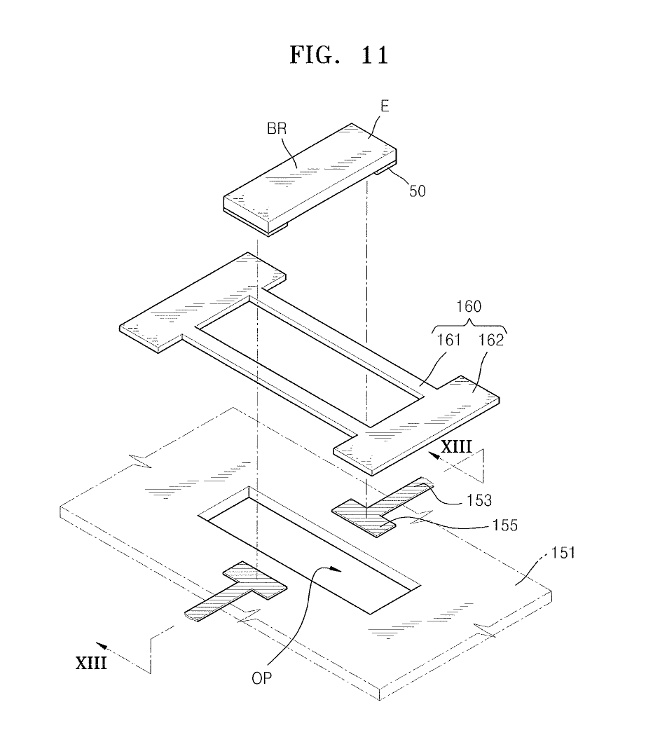

FIG. 9 is a perspective view of the heat dissipation structure of a balancing resistor according to another embodiment. FIG. 10 is a cross-sectional view taken along line X-X of FIG. 9. Referring to FIGS. 9 and 10, a plurality of balancing resistors BR1 and BR2′ may be arranged on the circuit board 151. The balancing resistors BR1 and BR2′ may be arranged on respective first and second surfaces 151a and 151b of the circuit board 151. That is, the balancing resistors BR1 and BR2′ may be formed on both surfaces 151a and 151b of the circuit board 151, so that an installation area on the circuit board 151 may be saved.

For example, the balancing resistors BR1 and BR2′ may share a heat dissipation opening and may be spaced apart from each other along a longitudinal direction of the heat dissipation opening. For example, the heat dissipation opening OP3 may extend across both the balancing resistors BR1 and BR2′. The heat dissipation opening OP3 may be shared by the balancing resistors BR1 and BR2′ formed on the first and second surfaces 151a and 151b of the circuit board 151, and the heat dissipation of the balancing resistors BR1 and BR2′ through the shared heat dissipation opening OP3 may be facilitated. For example, the heat dissipation opening OP may be formed in a rectangular shape extending in one direction, and the balancing resistors BR1 and BR2′ may be arranged on the first and second surfaces 151a and 151b of the circuit board 151 in a direction across the heat dissipation opening OP3.

For example, the balancing resistors BR1 and BR2′ may be formed at different positions on the first and second surfaces 151a and 151b of the circuit board 151. In other words, surfaces of the balancing resistors BR1 and BR2′ exposed through the heat dissipation opening OP3, i.e., the exposed surfaces of the balancing resistors BR1 and BR2′ facing the circuit board 151, may be arranged at different positions not to overlap with each other. Accordingly, the balancing resistors BR1 and BR2′ arranged on the first and second surfaces 151a and 151b may not thermally interfere with each other.

Installation lands 155 and 155′ for electrical connection to the balancing resistors BR1 and BR2′ may be patterned on the first and second surfaces 151a and 151b of the circuit board 151. Wiring patterns 153 and 153′ that are electrically connected to the installation lands 155 and 155′ may be formed together on the circuit board 151. As the connection electrode 50 formed on each of portions E1 and E2 of the balancing resistors BR1 and BR2′ is coupled a respective installation land 155 or 155′ on the first and second surfaces 151a and 151b, the balancing resistors BR1 and BR2′ may be installed on the circuit board 151.

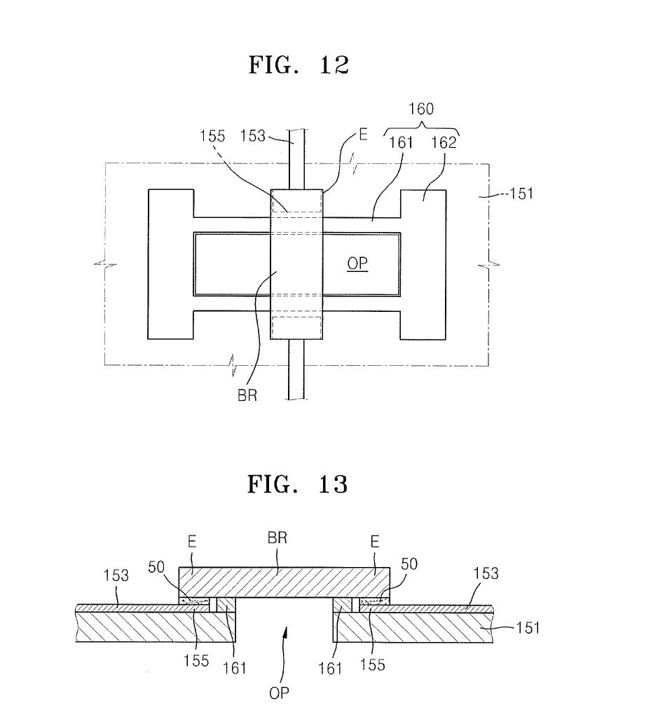

FIG. 11 is a perspective view of a heat dissipation structure of a balancing resistor according to another embodiment. FIG. 12 is a plan view of the heat dissipation structure of FIG. 11. FIG. 13 is a cross-sectional view along line XIII-XIII of FIG. 11. Referring to FIGS. 11-13, a heat dissipation pattern 160 may be formed with the heat dissipation opening OP on the circuit board 151 where the balancing resistor BR is installed.

The heat dissipation opening OP is an opening formed in the circuit board 151 to expose at least a part of the balancing resistor BR. The heat dissipation opening OP may be formed at a position where the balancing resistor BR is installed, and may overlap at least a part of the balancing resistor BR. The balancing resistor BR may dissipate resistance heat to the outside due to contact with lower temperature atmosphere through the heat dissipation opening OP without interference with the circuit board 151.

The heat dissipation pattern 160 may be formed on a surface of the circuit board 151 facing the balancing resistor BR, e.g., the heat dissipation pattern 160 may be formed between the circuit board 151 and the balancing resistor BR. The heat dissipation pattern 160 may be formed to overlap at least a part of the balancing resistor BR so as to have thermal contact with the balancing resistor BR. For example, the heat dissipation pattern 160 may have direct contact with the balancing resistor BR to receive the resistance heat of the balancing resistor BR, or may be formed at a position adjacent thereto where heat transfer is possible so as to receive the resistance heat of the balancing resistor BR, without having direct contact with the balancing resistor BR.

Referring to FIG. 13, the heat dissipation pattern 160 may include a first portion 161 in direct contact with a lower surface of the balancing resistor BR. The heat dissipation pattern 160 may be formed of a metal material exhibiting a superior heat conduction characteristic, e.g., copper foil or aluminum thin film. The first portion 161 of the heat dissipation pattern 160 may extend from the balancing resistor BR along a surface of the circuit board 151 in a direction across the balancing resistor BR.

The heat dissipation pattern 160 may rapidly dissipate the resistance heat of the balancing resistor BR to the outside through an extended area, thereby preventing accumulation of heat of the balancing resistor BR. The heat dissipation pattern 160 may function as a heat dissipation plate of the balancing resistor BR and may provide a large heat dissipation area by being extended over the surface of the circuit board 151.

In detail, the heat dissipation pattern 160 may include the first portion 161 having thermal contact with the balancing resistor BR and a second portion 162 providing a large heat dissipation area by being extended along the first portion 161 to the outside of the balancing resistor BR or the heat dissipation opening OP. The first portion 161 of the heat dissipation pattern 160 may extend in a direction across the balancing resistor BR. The second portion 162 may extend from the first portion 161 and may provide an enlarged heat dissipation area outside the heat dissipation opening OP.

The heat, dissipation pattern 160 may have thermal contact with the balancing resistor BR and may maintain an electrically insulated state. The heat dissipation pattern 160 may rapidly transfer the resistance heat of the balancing resistor BR to the outside through the thermal contact with the balancing resistor BR, i.e., through the thermal contact between the first portion 161 and the balancing resistor BR, and may simultaneously prevent electrical interference with a discharge circuit of the balancing resistor BR by maintaining electrical insulation from the balancing resistor BR. For example, the balancing resistor BR may secure an electrically insulated state from the heat dissipation pattern 160 through an insulation molding resin formed on an outer surface of the balancing resistor BR. In another embodiment, an insulation sheet (not shown) may be provided between the balancing resistor BR and the heat dissipation pattern 160.

For example, the heat dissipation pattern 160 may be formed to surround the heat dissipation opening OP. That is, the heat dissipation pattern 160 may be formed on the circuit board 151 along, e.g., a perimeter of, the heat dissipation opening OP. For example, the first and second portions 161 and 162 of the heat dissipation pattern 160 may be arranged to have a frame shape with an opening therethrough, so the opening may be identical to and may completely overlap the heat dissipation opening OP. As such, edges of the heat dissipating opening OP may be substantially coplanar with respective edges of the first and second portions 161 and 162 along planes perpendicular to a major plane of the circuit board 151. The proximity of the first and second portions 161 and 162 to the heat dissipating opening OP may directly expose the heat dissipation pattern 160 to an exterior atmosphere through the heat dissipating opening OP without blocking the heat dissipation opening OP. In this structure, the heat dissipation pattern 160 does not block the heat dissipation opening OP, so the balancing resistor BR may directly contact low-temperature atmosphere through the heat dissipation opening OP. Also, as the low-temperature atmosphere contacts the heat dissipation pattern 160 through the heat dissipation opening OP, the heat dissipation pattern 160 that is thermally connected to the balancing resistor BR may be cooled.

The balancing resistor BR may be arranged on the circuit board 151 across the heat dissipation opening OP and the heat dissipation pattern 160. In detail, the first portion 161 of the heat dissipation pattern 160 may be formed to surround the heat dissipation opening OP. The connection electrode 50 for the electrical connection to the circuit board 151 may be formed at both end portions E of the balancing resistor BR. The connection electrode 50 of the balancing resistor BR may be placed on and connected to the installation land 155 formed at both sides of the outside of the heat dissipation opening OP and the heat dissipation pattern 160.

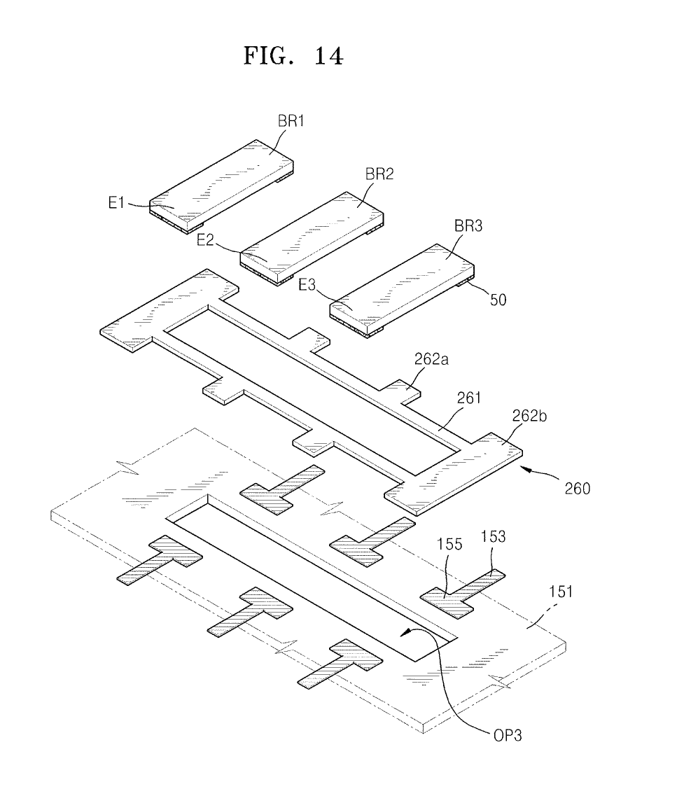

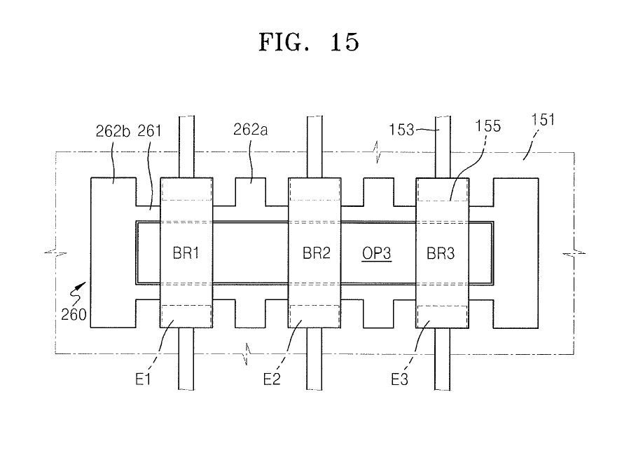

FIG. 14 is a perspective view of a heat dissipation structure of balancing resistors BR1, BR2, and BR3 according to another embodiment. FIG. 15 is a plan view of the heat dissipation structure of FIG. 14.

Referring to FIGS. 14 and 15, two or more balancing resistors, e.g., balancing resistors BR1, BR2, and BR3, may be arranged on the circuit board 151 of the BMS 150. For example, the balancing resistors BR1, BR2, and BR3 may be provided in a plural number to be connected to both ends of each of the unit batteries 10 and may form a discharge circuit with respect to each of the unit batteries 10 according to ON/OFF of a switching device, e.g., the balancing switches SWa, SWb, and SWc (see FIG. 3), connected to the balancing resistors BR1, BR2, and BR3.

The heat dissipation opening OP3 and a heat dissipation pattern 260 may be formed on the circuit board 151. The heat dissipation opening OP3 may be shared by the balancing resistors BR1, BR2, and BR3, and the heat dissipation of the balancing resistors BR1, BR2, and BR3 through the shared heat dissipation opening OP3 may be facilitated. For example, the heat dissipation opening OP3 may be formed in a rectangular shape extending in one direction. The balancing resistors BR1, BR2, and BR3 may be parallelly arranged in a direction across the heat dissipation opening OP3.

For example, the balancing resistors BR1, BR2, and BR3 may be installed on the circuit board 151 by using respective end portions E1, E2, and E3 on opposite sides of the heat dissipation opening OP3. The central area of each of the balancing resistors BR1, BR2, and BR3 may overlap and be exposed from the circuit board 151 through the heat dissipation opening OP3.

A group of the balancing resistors BR1, BR2, and BR3 formed on the circuit board 151 of the BMS 150 may share the heat dissipation pattern 260. For example, the heat dissipation pattern 260 may extend across, e.g., perpendicularly to, the balancing resistors BR1, BR2, and BR3. The heat dissipation pattern 260 may be extended along the circuit board 151 outside the balancing resistors BR1, BR2, and BR3, or along the circuit board 151 outside the heat dissipation opening OP, thereby providing an extended heat dissipation surface. The heat dissipation pattern 260 extending across the balancing resistors BR1, BR2, and BR3 may have thermal contact with the balancing resistors BR1, BR2, and BR3. The heat dissipation pattern 260 may extend to an area outside the balancing resistors BR1, BR2, and BR3 or the heat dissipation opening OP3, thereby providing a relatively large heat dissipation area in the outer area.

In detail, the heat dissipation pattern 260 may include a first portion 261 extending across the balancing resistors BR1, BR2, and BR3 at opposite sides of the heat dissipation opening OP3, and second portions 262a and 262b extending from the first portion 261 and providing a relatively large heat dissipation surface outside the balancing resistors BR1, BR2, and BR3 or the heat dissipation opening OP3. For example, the second portions 262a and 262b of the heat dissipation pattern 260 may include a branch portion 262a intermittently protruding, e.g., perpendicularly, to the lengthwise direction of the first portion 261 and extending between the balancing resistors BR1, BR2, and BR3, and an extension portion 262b extending from the end of the first portion 261 and having a heat dissipation surface extended from the first portion 261.

In the cell balancing operation, an overcharged one of the unit batteries 10 may be selected, and the overcharged unit battery 10 may be selectively discharged so that resistance heat may be concentrated on a part of the balancing resistors BR1, BR2, and BR3. The heat dissipation pattern 260 extending across the balancing resistors BR1, BR2, and BR3 may dissipate the resistance heat concentrated on the part of the balancing resistors BR1, BR2, and BR3. Further, the heat dissipation pattern 260 may remove temperature variation among the balancing resistors BR1, BR2, and BR3, so that a resistance characteristic of the balancing resistors BR1, BR2, and BR3 may be maintained constant.

The heat dissipation pattern 260 may be formed in a shape surrounding the heat dissipation opening OP3, i.e., not to block the heat dissipation opening OP3, so that the balancing resistors BR1, BR2, and BR3 exposed through the heat dissipation opening OP3 may directly contact the atmosphere. Also, the low-temperature atmosphere input through the heat dissipation opening OP3 may contact the heat dissipation pattern 260, thereby cooling the heat dissipation pattern 260 that is thermally connected to the balancing resistors BR1, BR2, and BR3.

The balancing resistors BR1, BR2, and BR3 may be installed on the circuit board 151 across, e.g., substantially perpendicularly to, the heat dissipation opening OP3 and the heat dissipation pattern 260. The first portion 261 of the heat dissipation pattern 260 may be formed to surround the heat dissipation opening OP3. The balancing resistors BR1, BR2, and BR3 may be connected to the installation land 155 formed at both sides outside the heat dissipation opening OP3 and the heat dissipation pattern 260. The balancing resistors BR1, BR2, and BR3 may directly contact the first portion 261 by extending across the first portion 261 of the heat dissipation pattern 260. However, the balancing resistors BR1, BR2, and BR3 and the heat dissipation pattern 260 may be separated with a gap capable of performing thermal transfer therebetween. The connection electrode 50 for the electrical connection to the installation land 155 may be formed at a position corresponding to the installation land 155 of the circuit board 151, i.e., at end portions E1, E2, and E3 of the balancing resistors BR1, BR2, and BR3.

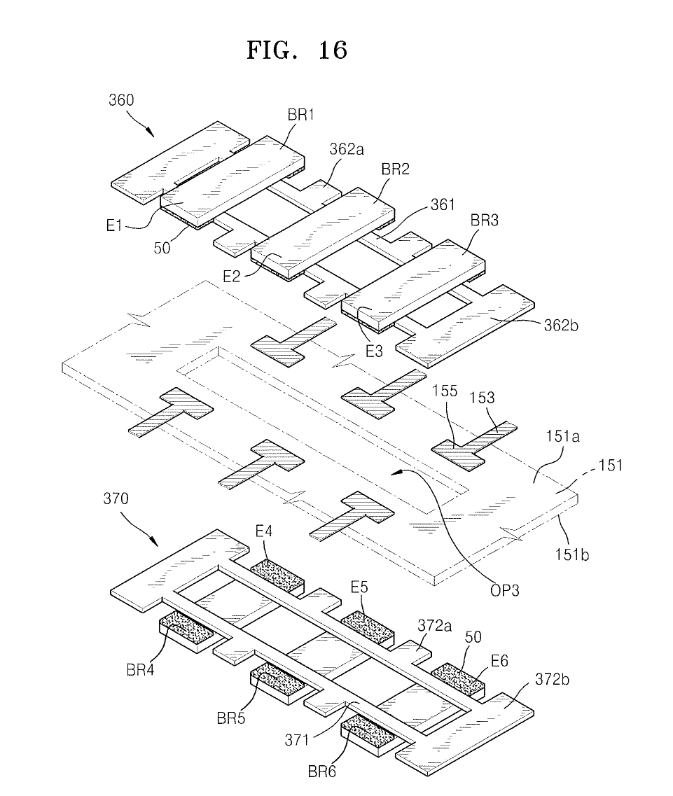

FIG. 16 is a perspective view of the heat dissipation structure of balancing resistors BR1, BR2, BR3, BR4, BR5, and BR6 according to another embodiment. Referring to FIG. 16, a plurality of balancing resistors BR1, BR2, BR3, BR4, BR5, and BR6 may be installed on the circuit board 151. The balancing resistors BR1, BR2, BR3, BR4, BR5, and BR6 may be arranged over the first and second surfaces 151a and 151b of the circuit board 151. For example, as the balancing resistors BR1, BR2, BR3, BR4, BR5, and BR6 connected to the unit batteries 10 of a secondary battery are distributed over the first and second surfaces 151a and 151b of the circuit board 151, an installation area of the circuit board 151 may be increased.

The circuit board 151 may be provided with the heat dissipation opening OP3 formed across the balancing resistors BR1, BR2, BR3, BR4, BR5, and BR6. The heat dissipation opening OP3 may be shared by the balancing resistors BR1, BR2, BR3, BR4, BR5, and BR6 formed on the first and second surfaces 151a and 151b of the circuit board 151. The heat dissipation of the balancing resistors BR1, BR2, BR3, BR4, BR5, and BR6 through the heat dissipation opening OP may be facilitated.

Heat dissipation patterns 360 and 370 for facilitating the heat dissipation of the balancing resistors BR1, BR2, BR3, BR4, BR5, and BR6 with the heat dissipation opening OP3 may be formed on the circuit board 151. The heat dissipation patterns 360 and 370 may be formed to overlap at least a part of the balancing resistors BR1, BR2, BR3, BR4, BR5, and BR6 and have thermal contact with the balancing resistors BR1, BR2, BR3, BR4, BR5, and BR6. The heat dissipation patterns 360 and 370 may dissipate resistance heat from the balancing resistors BR1, BR2, BR3, BR4, BR5, and BR6 through an extended heat dissipation surface by rapidly transferring the resistance heat to the outside.

The heat dissipation patterns 360 and 370 may be formed across a group of the balancing resistors BR1, BR2, BR3, BR4, BR5, and BR6. The heat dissipation patterns 360 and 370 may provide an extended heat dissipation surface by being extended along the circuit board 151 outside the balancing resistors BR1, BR2, BR3, BR4, BR5, and BR6, or along the circuit board 151 outside the heat dissipation opening OP3.

The heat dissipation patterns 360 and 370 may include a first heat dissipation pattern 360 and a second heat dissipation pattern 370 which are respectively formed on the first and second surfaces 151a and 151b of the circuit board 151. The first heat dissipation pattern 360 may thermally interact with the balancing resistors BR1, BR2, and BR3 on the first surface 151a. The second heat dissipation pattern 370 may thermally interact with the balancing resistors BR4, BR5, and BR6 on the second surface 151b.

The first and second heat dissipation patterns 360 and 370 may respectively include first portions 361 and 371 formed on the first and second surfaces 151a and 151b and extending across the balancing resistors BR1, BR2, BR3, BR4, BR5, and BR6, and second portions 362a, 362b, 372a, and 372b extending from the first portions 361 and 371 and providing a relatively large heat dissipation surface by being extended to the outside of the balancing resistors BR1, BR2, BR3, BR4, BR5, and BR6 or the heat dissipation opening OP3.

For example, the second portions 362a, 362b, 372a, and 372b of the first and second heat dissipation patterns 360 and 370 may include branch portions 362a and 372a intermittently and perpendicularly protruding relative to the lengthwise direction of the first portions 361 and 371 and extending between the balancing resistors BR1, BR2, BR3, BR4, BR5, and BR6 and extension portions 362b and 372b extending from the ends of the first portions 361 and 371 and providing an extended heat dissipation surface.

The connection electrode 50 for the electrical connection to the installation land 155 of the circuit board 151 may be formed on end portions E1, E2, E3, E4, E5, and E6 of respective balancing resistors BR1, BR2, BR3, BR4, BR5, and BR6. The connection electrode 50 of the balancing resistors BR1, BR2, BR3, BR4, BR5, and BR6 may be coupled to the installation land 155 formed at opposite sides of the outside of the heat dissipation opening OP3 and the heat dissipation patterns 360 and 370. That is, the balancing resistors BR1, BR2, BR3, BR4, BR5, and BR6 may be extended across the heat dissipation opening OP3 and the heat dissipation patterns 360 and 370. The connection electrode 50 formed on end portions E1, E2, E3, E4, E5, and E6 of respective balancing resistors BR1, BR2, BR3, BR4, BR5, and BR6 may be coupled to the installation land 155 formed outside the heat dissipation opening OP3 and the heat dissipation patterns 360 and 370.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a plurality of unit batteries;
a circuit board having at least one heat dissipation opening therethrough; and
a balancing circuit on the circuit board, the balancing circuit including:
at least one balancing switch configured to switch ON/OFF states according to an output signal of a control unit, and
at least one balancing resistor configured to form a discharge circuit of the plurality of unit batteries according to the ON/OFF states of the balancing switch, at least a part of the balancing resistor being exposed through the at least one heat dissipation opening in the circuit board.

2. The secondary battery as claimed in claim 1, wherein the balancing resistor extends across the heat dissipation opening, opposite end portions of the balancing resistor being on opposite sides of the heat dissipation opening and coupled to an installation land of the circuit board.

3. The secondary battery as claimed in claim 1, further comprising a heat dissipation pattern extending along a surface of the circuit board and facing the balancing resistor, the heat dissipation pattern having thermal contact with at least a part of the balancing resistor.

4. The secondary battery as claimed in claim 3, wherein the heat dissipation pattern surrounds the heat dissipation opening.

5. The secondary battery as claimed in claim 3, wherein the heat dissipation pattern includes:
a first portion extending along a first direction to cross the balancing resistor, the first portion having thermal contact with the balancing resistor; and
a second portion extending along a second direction from the first portion, the second portion being configured to provide a heat dissipation surface and having a width along the first direction larger than a width of the first portion along the second direction.

6. The secondary battery as claimed in claim 5, wherein the first portion extends along two opposite sides of the heat dissipation opening, and the second portion extends along two opposite sides of the heat dissipation opening.

7. The secondary battery as claimed in claim 3, wherein the balancing resistor is arranged across the heat dissipation opening and the heat dissipation pattern, opposite end portions of the balancing resistor being coupled to an installation land of the circuit board at opposite sides of the heat dissipation opening and the heat dissipation pattern.

8. The secondary battery as claimed in claim 1, wherein at least two balancing resistors are arranged on the circuit board, the at least two balancing resistors corresponding to different discharge circuits connected to different unit batteries.

9. The secondary battery as claimed in claim 8, wherein the heat dissipation opening overlaps the at least two balancing resistors.

10. The secondary battery as claimed in claim 8, further comprising a heat dissipation pattern extending along a surface of the circuit board and facing the at least two balancing resistors, the heat dissipation pattern having thermal contact with the at least two balancing resistors.

11. The secondary battery as claimed in claim 10, wherein the heat dissipation pattern surrounds the heat dissipation opening.

12. The secondary battery as claimed in claim 10, wherein the heat dissipation pattern includes:
a first portion extending across the at least two balancing resistors and having thermal contact with the at least two balancing resistors; and
a second portion extending outside of the first portion and providing a heat dissipation surface extended from the first portion.

13. The secondary battery as claimed in claim 12, wherein the first portion extends across the at least two balancing resistors along two opposite sides of the heat dissipation opening, and the second portion includes:
a branch portion protruding from the first portion extending between the at least two balancing resistors; and
an extension portion outside the heat dissipation openings and connecting the first portion on the opposite sides of the heat dissipation opening, the extension portion being configured to provide a heat dissipation surface.

14. The secondary battery as claimed in claim 10, wherein the at least two balancing resistors are parallel to each other and extend across the heat dissipation opening and the heat dissipation pattern, opposite end portions of the at least two balancing resistors being coupled to the installation land of the circuit board at opposite sides of the heat dissipation opening and the heat dissipation pattern.

15. The secondary battery as claimed in claim 8, wherein the at least two balancing resistors are on opposite surfaces of the circuit board, the heat dissipation opening overlapping the at least two balancing resistors.

16. The secondary battery as claimed in claim 15, wherein the at least two balancing resistors are at different positions on the circuit board not to overlap with each other through the heat dissipation opening.

17. The secondary battery as claimed in claim 15, further comprising a first heat dissipation pattern and a second heat dissipation pattern on the opposite surfaces of the circuit board, respectively, the first and second heat dissipation patterns contacting the at least two balancing resistors, respectively.

18. The secondary battery as claimed in claim 1, wherein a surface of the circuit board facing the unit batteries is positioned at a predetermined distance from the unit batteries to define a space therebetween, the at least one balancing resistor being exposed to the space between the circuit board and unit batteries through the opening of the circuit board.
